(19) United States
(12) Patent Application Publication
(10) Pub. No.: US 2018/0055064 A1
(43) Pub. Date: Mar. 1, 2018

(54) PROCESS FOR USING THERMAL TREATMENT TO MODIFY AND CONTROL THE MELT PROPERTIES OF NATURAL CHEESE

(71) Applicant: Hilmar Cheese Company, Hilmar, CA (US)

(72) Inventors: Jeremy McLeod., Turlock, CA (US); Gabrielle Alyss Gunter, Charleston, SC (US); Mykola Shynkaryk, Turlock, CA (US)

(73) Assignee: Hilmar Cheese Company, Hilmar, CA (US)

(21) Appl. No.: 15/691,959

(22) Filed: Aug. 31, 2017

Related U.S. Application Data
(60) Provisional application No. 62/382,136, filed on Aug. 31, 2016.
(60) Provisional application No. 62/547,565, filed on Aug. 18, 2017.

(51) Int. Cl. A23C 19/08; A23C 19/068; A23C 19/097

(52) U.S. Cl. CPC A23C 19/08; A23V 2002/00; A23C 19/0973; A23C 19/0684

(57) ABSTRACT

Heating the natural cheese to cause at least one of modification of the structural chemistry of the proteins, completely or partially denaturing proteins, and inactivating proteolytic enzymes, lipolytic enzymes, and microbial organisms within the cheese allows for the cheese to be fried or grilled while maintaining its consistency and shape, baked as Juustoleipa; heated and mechanically processed as in cooking-stretching process used for mozzarella. The method produces cheese with various structural and melting properties using a single recipe and manufacturing facility.

### CROSS-REFERENCE TO RELATED APPLICATIONS

This application claims priority to U.S. Provisional Application No. 62/547,565, filed Aug. 18, 2017; and to U.S. Provisional Application No. 62/382,136, filed Aug. 31, 2016; herein incorporated by reference.

### FIELD

The disclosure relates generally to dairy products. The disclosure relates specifically to cheese production.

### BACKGROUND

Upon heating, natural cheese typically undergoes a melting process that leads to a loss of its initial shape and consistency. In some applications, the melting process of cheese causes it to be lost from the bulk food structure. Current solutions to modify the melt and functional properties of cheese use different solutions such as exposing cheese to hot whey as in Halloumi cheese; baking as in Juustoleipa; including additives, such as emulsifying salts, as in processed cheese; or heat and mechanical processing as in the cooking-stretching process used for mozzarella. The above manufacturing practices require dedicated recipes and manufacturing facilities for each type of cheese. This disclosure offers a method and a process to produce cheese with various structural and melting properties using single recipe and manufacturing facility.

It would be advantageous for various applications, including frying, grilling, or baking, to have a natural cheese that maintains its shape and consistency upon heating. It would useful to have a process to alter the melting properties of cheese that does not require additives or mechanical processes.

### SUMMARY

An embodiment of the disclosure is a method of producing a cheese for grilling or frying applications comprising: controlling a consistency of flow and shape of the cheese upon heating; controlling a degree of oiling off of the cheese; and controlling a desired degree of melting of the cheese while controlling the degree of oiling off of the cheese.

In an embodiment, the heating of the cheese is by the method selected from the group comprising steam, infrared, convection, induction, ohmic, microwave, radio frequency, and a combination thereof. In an embodiment, the method further comprises modifying the chemistry of the cheese. In an embodiment, modifying the chemistry of the cheese comprises differences in the binding of calcium by casein. In an embodiment, the method further comprises denaturing the proteins within a cheese mass. In an embodiment, the method further comprises inactivating proteolytic enzymes, lipolytic enzymes, and microbial organisms within the cheese. In an embodiment, the age of the cheese ranges from fresh curd to 52 weeks. In an embodiment, the cheese is aged to a desired degree of proteolysis. In an embodiment, a desired temperature ranges from 50° C. to 170° C. In an embodiment, the desired temperature ranges from 90° C. to 110° C. In an embodiment, the desired holding time ranges from 0 to 12 hours. In an embodiment, the desired holding time ranges from 5 minutes to 30 minutes. In an embodiment, the heating of the cheese does not use an electrically conductive fluid. In an embodiment, the heating the cheese uses an electrically conductive fluid. In an embodiment, the electrically conductive fluid comprises whey, deproteinized whey, brine, water, or a mixture thereof. In an embodiment, the cheese is treated in a form selected from the group comprising curd, particles, ground cheese, shredded cheese, blocks, and extruded cheese. In an embodiment, the cheese is immobile relative to the source of the heat. In an embodiment, the cheese moves along the source of the heat. In an embodiment, an applied electric field is comprised of monopolar pulses. In an embodiment, an applied electric field is comprised of bipolar pulses. In an embodiment, an applied electric field has pulses with a fixed or adjustable duration. In an embodiment, an applied electric field has delays between pulses. In an embodiment, an applied electric field does not have delays between pulses. In an embodiment, the frequency of pulses ranges from 0 Hz to 1 MHz. In an embodiment, the desired frequency ranges from 10 kHz to 400 kHz. In an embodiment, one or more electrodes are comprised of a food grade electrically conductive material. In an embodiment, the heating of the cheese utilizes one or more electrodes selected from the group comprising stainless steel, titanium, platinized titanium, or a mixture thereof. In an embodiment, the electrically conductive material comprises at least one selected from the group comprising stainless steel, titanium, platinized titanium, or a mixture thereof. In an embodiment, the one or more electrodes is two or more electrodes. In an embodiment, the method further comprises holding the cheese at a temperature in the fixed form after heating; followed by cooling, to obtain a desired final form of the cheese that is the same as a starting form of the cheese. In an embodiment, the cheese is packaged and cooled to storage temperature by direct or indirect exposure to a cooling agent comprising air, liquid nitrogen, carbon dioxide, whey, deproteinized whey, brine, water, or a mixture thereof. In an embodiment, the cheese is transformed into a new shape by a process comprising pressing, molding, rolling, or extruding to obtain a desired final form of the cheese different from a starting form. In an embodiment, the cheese is cooled to a desired temperature after processing. In an embodiment, the cheese is cooled by direct exposure to a cooling agent comprising air, liquid nitrogen, carbon dioxide, whey, deproteinized whey, brine, water, or a mixture thereof. In an embodiment, the method further comprises forming the cheese into a desired shape before cooling the cheese to a desired temperature. In an embodiment, the method further comprises forming the cheese into a desired shape before holding the cheese at a desired temperature for a desired time.

An embodiment of the disclosure is a method of inactivating proteolytic enzymes, lipolytic enzymes, and microbial organisms within the cheese by a method comprising heating the cheese to a desired temperature; holding the cheese at a desired temperature for a desired time; and cooling the cheese to a desired temperature; wherein the cheese obtained maintains desirable functional properties for an extended period of time after the treatment application.

An embodiment of the disclosure is a method and process of producing a cheese that maintains its consistency and shape upon application of heat, grilling, or frying. This process inactivates proteolytic enzymes, lipolytic enzymes, and microbial organisms within the cheese by a method comprising heating the natural cheese at desired age to a desired temperature using an applied electric field provided by electrodes; and holding the cheese at a desired temperature for a desired time; cooling the cheese to a desired temperature; wherein the cheese obtained maintains its consistency and shape after application of the heating, grilling or frying.

In an embodiment, the process of heating the cheese is selected from the group comprising steam, infrared, convection, induction, microwave, ohmic, microwave, radio frequency, and combinations thereof.

In an embodiment, the process of heating the cheese is selected from the group consisting of steam, infrared, convection, induction, microwave, ohmic, microwave, radio frequency, and combinations thereof.

In an embodiment, the method further comprises modifying the chemistry and functionality of the cheese. In an embodiment, modifying the chemistry and functionality of the cheese comprises controlling the degree of hydrolysis of the caseins. In an embodiment, modifying the functionality of the cheese comprises differences in the binding of calcium by casein. In an embodiment, the method further comprises modifying the chemistry of the cheese by thermally denaturing the proteins within a cheese mass. In an embodiment, the proteolytic and lipolytic enzymes as well as the cheese microbiota are thermally inactivated. In an embodiment, the age of the cheese ranges from fresh curd to 52 weeks. In an embodiment, the desired temperature ranges from 50° C. to 170° C. In an embodiment, the desired temperature ranges from 90° C. to 110° C. In an embodiment, the desired heating time ranges from 5 seconds to 12 hours. In an embodiment, the desired heating time ranges from 5 minutes to 60 minutes. In an embodiment, the desired holding time ranges from 0 to 12 hours. In an embodiment, the desired holding time ranges from 5 minutes to 60 minutes.

In an embodiment, no fluid is used in heating the cheese. In an embodiment, an electrically conductive fluid is used in heating the cheese. In an embodiment, the electrically conductive fluid comprises whey, deproteinized whey, brine, water, or a mixture thereof. In an embodiment, the cheese mass is treated in the form of one selected from the group consisting of curd, particles, ground cheese, shredded cheese, blocks, and extruded. In an embodiment, the cheese mass is immobile relative to the source of the heat. In an embodiment, the cheese mass moves along the source of the heat. In an embodiment, the cheese mass is in direct contact with electrically conductive material. In an embodiment, the cheese mass is in direct contact with dielectric material.

In an embodiment, an electromagnetic field is applied to the cheese. In an embodiment, the applied electromagnetic field is in ohmic heating range. In an embodiment, the applied electromagnetic field is in RF range. In an embodiment, the applied electromagnetic field is in microwave range. In an embodiment, an ohmic, RF or microwave energy is applied across the cheese mass. In an embodiment, an alternate electric field is comprised of monopolar pulses. In an embodiment, the applied electric field is comprised of bipolar pulses. In an embodiment, the applied electric field has pulses with a fixed or adjustable duration. In an embodiment, the applied electric field has delays between pulses. In an embodiment, the applied electric field does not have delays between pulses. In an embodiment, the frequency of ohmic pulses ranges from 0 Hz to 1 MHz. In an embodiment, the desired frequency ranges from 10 kHz to 400 kHz. In an embodiment, the frequency of RF heating is from about 1 MHz to about 100 MHz. In an embodiment, the frequency of microwave field is within the range of frequencies from about 300 MHz to 3 GHz. The ohmic, RF and microwave energy can be used at any of the above frequency ranges. The applied electromagnetic field at any of the above frequencies ranges may also have harmonic components. In an embodiment, the electrodes are comprised of a food grade electrically conductive material. In an embodiment, the electrically conductive material is comprised of stainless steel, titanium or platinized titanium. In an embodiment, the electrodes number two or more electrodes.

In an embodiment, the cheese mass, once heated to the desired temperature is then held at this temperature for a required length of time. The same or one of known heating technologies may be used at this point, such as direct contact with a hot surface, steaming, radiofrequency heating, microwave heating or the combination of the above.

If the starting form of the cheese mass is the desired final form then the cheese is held at temperature in the fixed form and then cooled. If the desired form is different from the starting form then the molten dough like state is taken advantage of allowing the cheese to be transformed into a new shape. In an embodiment, the cheese may be made into rolls, sheets or blocks that fit the dimensions of the desired application by a process of pressing, molding, rolling or extruding or similar technology. In this case the holding time at the target temperature may occur before or after the shape transformation process. At this point the product can be directly exposed to the source of the heat or through a layer of temporary or final packaging material protecting the product from excessive moisture losses or absorption. Following heating, holding and forming the cheese is then cooled. In an embodiment, the cheese is cooled by direct or indirect exposure to a cooling agent comprising air, liquid nitrogen, carbon dioxide, whey, deproteinized whey, brine, water, or a mixture thereof. From there is can be packaged or further cut to a size suitable for the final application.

The foregoing has outlined rather broadly the features of the present disclosure in order that the detailed description that follows may be better understood. Additional features and advantages of the disclosure will be described hereinafter, which form the subject of the claims.

### BRIEF DESCRIPTION OF THE DRAWINGS

In order that the manner in which the above-recited and other enhancements and objects of the disclosure are obtained, a more particular description of the disclosure briefly described above will be rendered by reference to specific embodiments thereof which are illustrated in the appended drawings. Understanding that these drawings depict only typical embodiments of the disclosure and are therefore not to be considered limiting of its scope, the disclosure will be described with additional specificity and detail through the use of the accompanying drawings in which:

FIGS. 1A and 1B depict graphs of the storage modulus (G′), loss modulus (G″), and phase angle of the cheese as a function of temperature. FIG. 1A depicts the storage modulus (G′), loss modulus (G″), and phase angle for cheese where melt occurs and FIG. 1B depicts storage modulus (G′), loss modulus (G″), and phase angle for cheese where no melt occurs.

FIG. 2 depicts a flow chart of an embodiment of a process for using heat to modify the chemistry; denature the proteins within a cheese mass; and inactivate proteolytic enzymes, lipolytic enzymes, and microbial organisms within the cheese mass. Included are transformation into a new shape by a process of pressing, molding, rolling, extruding or similar technology if the desired form is different from the starting form; cheese holding at target temperature before or after the shape transformation process using one of known heating technologies, such as direct contact with a hot surface, steaming, immersion in a hot fluid such as water, radiofrequency heating, microwave heating, or combinations of the above; cheese cooling by direct or indirect exposure to a cooling agent comprising air, liquid nitrogen, carbon dioxide, whey, deproteinized whey, brine, water, or a mixture thereof. The cheese can be packaged or further cut to a size suitable for the final application.

FIG. 3 depicts different flow chart combinations of an embodiment of a process for using heat to modify the chemistry, denature the proteins within a cheese mass; and inactivate proteolytic enzymes, lipolytic enzymes, and microbial organisms within the cheese mass.

### DETAILED DESCRIPTION

The particulars shown herein are by way of example and for purposes of illustrative discussion of the preferred embodiments of the present disclosure only and are presented in the cause of providing what is believed to be the most useful and readily understood description of the principles and conceptual aspects of various embodiments of the disclosure. In this regard, no attempt is made to show structural details of the disclosure in more detail than is necessary for the fundamental understanding of the disclosure, the description taken with the drawings making apparent to those skilled in the art how the several forms of the disclosure may be embodied in practice.

The following definitions and explanations are meant and intended to be controlling in any future construction unless clearly and unambiguously modified in the following examples or when application of the meaning renders any construction meaningless or essentially meaningless. In cases where the construction of the term would render it meaningless or essentially meaningless, the definition should be taken from Webster's Dictionary 3^{rd} Edition.

As used herein, the term “protein hydrolysis” means and refers to a process in which proteins are broken down into smaller peptides or amino acids by proteolytic enzymes.

As used herein, the term “denaturation” means and refers to a process in which proteins lose their three-dimensional structures. The three-dimensional structure of a protein is the structure of the protein in its native state.

As used herein, the term “chemistry” is used to describe the interactions of the components within the cheese with each other and individually. These components include, milk fat, milk protein, water, calcium, phosphate, sodium, chloride, sugars such as lactose, organic acids such as lactate and citrate, milk minerals, and any enzymes which may have been added or are naturally occurring in the milk or cheese.

As used herein, the term “proteolytic enzyme inactivation” means and refers to a process in which proteolytic enzymes lose their ability to breakdown proteins into smaller polypeptides or amino acids.

As used herein, the term “lipolytic enzyme inactivation” means and refers to a process in which lipolytic enzymes lose their ability to breakdown lipids into glycerol and free fatty acids.

As used herein, the term “microbial organism inactivation” means and refers to a process in which microbial organisms are damaged or killed and lose their reproductive capability.

As used herein, the term “steam heating” means and refers to a process where high-temperature water vapor is used to heat the cheese mass.

As used herein, the term “ohmic heating” means and refers to a process where electric current is dissipated into the heat while passing through an electrically conductive cheese mass.

As used herein, the term “RF” and “microwave heating” means and refers to a process where electromagnetic field is dissipated into the heat while passing through a cheese mass.

Steam, ohmic, RF and microwave heating can be used for the purpose of heating the material, heating foods to serving temperature as well as in dehydration, evaporation, blanching, pasteurization, and sterilization food processing technological operations.

A natural cheese of desired functionality can be obtained by taking natural cheese with a desired level of intact casein and heating it to a temperature that modifies the protein structure and cheese chemistry in such a way that after cooling, the protein network in the cheese is no longer altered by enzyme or acids produced by starter and non-starter bacteria. One or all can be occurring: enzymes and bacteria inactivation, denaturation and modification of the cheese chemistry.

Casein is a dominant class of proteins in milk, constituting about four-fifths of the milk proteins. There are four main types of casein, as1-casein, as2-casein, κ-casein and β-casein. The caseins self-organize and form large micelles which vary in size from 50 to 500 nm. The micelles outer hairy κ-casein layer is hydrophilic and negatively charged and gives a major contribution to the stability of the micelles in a suspension. During the cheese making, the hydrophilic chain end of κ-casein is split by adding rennet and the micelles will start to aggregate and form the curd. The casein micelle aggregates are linked together by small regions of calcium phosphate giving the cheese an open and porous structure.

Generally, casein can maintain its structure at temperature of approximately 70° C., a temperature at which the whey protein present in milk denatures. In the present method, it is possible to alter casein micelles by denaturing whey proteins present within the cheese. The denaturation of casein with heat treatment can also occur by the effect of heat on calcium phosphate and/or the phosphoserine residues of casein (Gaucheron F. 2005).

In an embodiment, whey protein can include β-lactoglobulin, α-lactoalbumin, glycomacropeptide, proteose peptone 3, immunoglobulins, serum albumin, lactoferrin, and other non-casein milk derived proteins.

In an embodiment, the proposed method of heating for cheese processing uses the technology for complete or partial denaturation of dairy proteins in order to obtain a cheese product of the desired functionality which can be fried, grilled, or baked while maintaining its consistency and shape, shaped into typical pasta-filata shapes without oiling off or give desired oiling off and stretching in pizza type applications. The efficiency of the manufacturing process and the quality of the final product are expected to be superior compared to the conventional practice.

In an embodiment, various types of modification of the chemistry of the cheese can occur. The modifications can occur on individual proteins and/or in the interactions between proteins, minerals, and other components, such as milk fat. The various types of modifications that can occur to casein and/or whey proteins include, but are not limited to, binding of minerals including, but not limited to, calcium, magnesium, zinc, iron, sodium, potassium, chloride, phosphorus, copper, manganese, iodine, fluoride, selenium, cobalt, chromium, molybdenum, nickel, arsenic, silicon, and boron; trace elements; reduction of disulfide bonds; disulfide exchange; phosphorylation, and dephosphorylation. In an embodiment, there is a change in binding of calcium, magnesium, zinc, iron, or sodium by casein and/or whey proteins. In an embodiment, there is a change in binding of calcium by casein and/or whey proteins.

In an embodiment, the disclosure offers a method that allows natural cheese to be manufactured in such a way that its melt properties can be controlled and restricted, allowing it to be used in applications where maintenance of consistency is required (such as grilling, frying, and deep frying) or in applications where flow would lead to the cheese being lost from the bulk food structure (such as in baked goods or breaded goods (for example, mozzarella sticks), where the cheese used often creates a problem of “blowout”). In an embodiment, the disclosed process can be used to modify the melt, shelf life, and functional properties of natural cheese. In an embodiment, the shelf life of the cheese is extended after performance of the method.

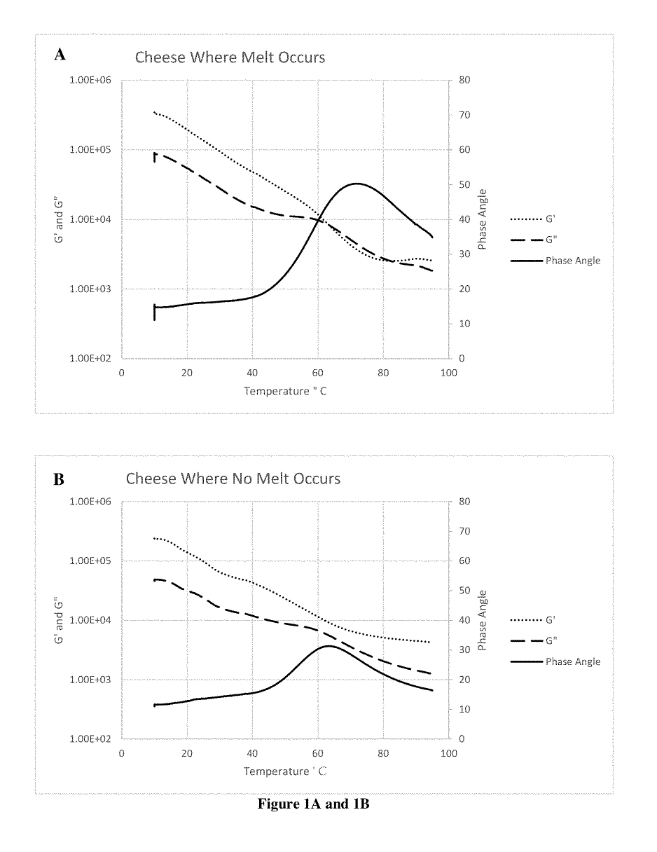

One way to examine the impact of the treatment is to measure storage and loss moduli of the cheese as a function of temperature. Where the appropriate heat treatment has been applied, a change in the relationship between these two variables can be seen. Where no melt occurs, there is no crossing of the storage and loss moduli. This is shown in FIG. 1.

In an embodiment, the disclosure offers a method that allows natural cheese to be manufactured in such a way that its stretching and oiling off properties can be controlled and restricted, allowing it to be used in applications where a good stretch and retention of fat within the structure are required (product in pasta-filata type cheeses) or where both, some degree of oiling off and stretching, are required (pizza industry applications).

The disclosure also allows for varying degrees of melt to be developed. Additionally, through the thermal treatment, the oiling off of the cheese is limited, allowing the cheese to be used in applications where processed cheese is typically used, as the cheese shows similar properties to processed cheese, with limited melt and flow and also retention of fat within the structure.

In an embodiment, the treatment also prevents the cheese from sticking. Sticking together of the cheese occurs when the cheese is shredded or individual slices are formed, as the cheese does not need anticaking agents (e.g., powdered cellulose) or a physical separation such as parchment paper or plastic film.

In an embodiment, the method further comprises modifying the functionality of the cheese. In an embodiment, modifying the functionality of the cheese comprises controlling the degree of hydrolysis of the caseins and denaturation within the cheese. In an embodiment, modifying the functionality of the cheese comprises differences in the binding of calcium by casein. In an embodiment, the method further comprises modifying the chemistry of the cheese by thermally denaturing the proteins within a cheese mass. In an embodiment, the proteolytic and lipolytic enzymes as well as the cheese microbiota are thermally inactivated. In an embodiment, the age of the cheese ranges from fresh curd to several months. In an embodiment, the desired temperature ranges from 50° C. to 170° C. In an embodiment, the desired temperature ranges from 90° C. to 110° C. In an embodiment, the desired heating time ranges from 5 seconds to 12 hours. In an embodiment, the desired heating time ranges from 5 minutes to 30 minutes. In an embodiment, the desired holding time ranges from 0 to 12 hours. In an embodiment, the desired holding time ranges from 5 minutes to 30 minutes.

In an embodiment, the process of heating the cheese is selected from the group comprising steam, infrared, convection, induction, microwave, ohmic, microwave, radio frequency, and a combination thereof.

In an embodiment, the process of heating the cheese is selected from the group consisting of steam, infrared, convection, induction, microwave, ohmic, microwave, radio frequency, and a combination thereof.

In an embodiment, no fluid is used in heating the cheese. In an embodiment, an electrically conductive fluid is used in heating the cheese. In an embodiment, the electrically conductive fluid comprises whey, deproteinized whey, brine, water, or a mixture thereof. In an embodiment, the cheese mass is treated in the form of one selected from the group consisting of curd, particles, ground cheese, shredded cheese, blocks, and extruded. In an embodiment, the cheese mass is immobile relative to the heat source. In an embodiment, the cheese mass moves along the heat source. In an embodiment, the cheese mass is in direct contact with electrically conductive material. In an embodiment, the cheese mass is in direct contact with dielectric material.

In an embodiment, an alternating electromagnetic field is applied to the cheese. In an embodiment, the applied electromagnetic field is in RF range. In an embodiment, the applied electromagnetic field is in microwave range. In an embodiment, an alternating electromagnetic field is applied across the cheese mass. In an embodiment, an electromagnetic field is comprised of monopolar pulses. In an embodiment, the applied electromagnetic field is comprised of bipolar pulses. In an embodiment, the applied electromagnetic field has pulses with a fixed or adjustable duration. In an embodiment, the applied electromagnetic field has delays between pulses. In an embodiment, the applied electromagnetic field does not have delays between pulses. In an embodiment, the frequency of ohmic heating ranges from 0 Hz to 1 MHz. In an embodiment, the desired frequency ranges from 10 kHz to 400 kHz. In an embodiment, the frequency of RF heating is from about 1 MHz to about 100 MHz. In an embodiment, the frequency of microwave field is within the range of frequencies from about 300 MHz to 3 GHz. The ohmic, RF, and microwave energy can be used at any of the above frequency ranges. The applied electromagnetic field at any of the above frequencies ranges can also have harmonic components.

In an embodiment, the electrodes for ohmic heating are comprised of a food grade electrically conductive material. In an embodiment, the electrically conductive material is comprised of stainless steel, titanium, or platinized titanium. In an embodiment, there are two or more electrodes.

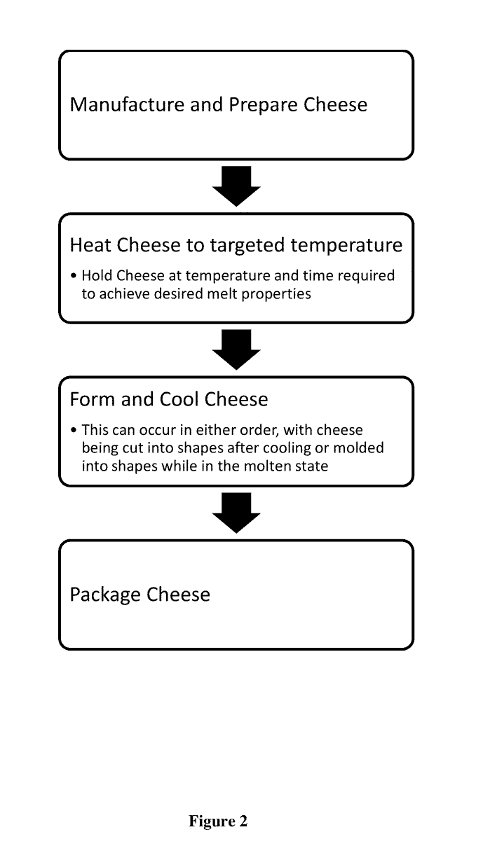

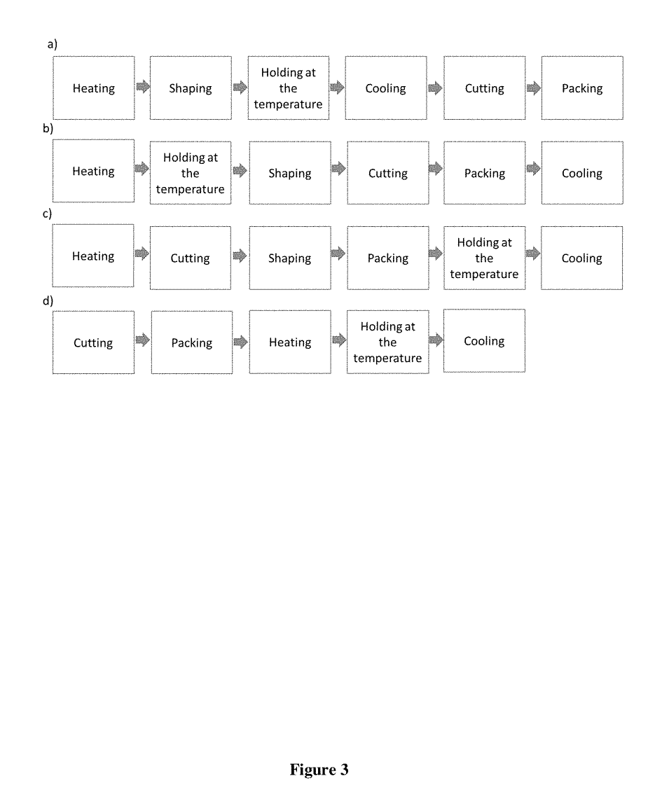

FIG. 2 and FIG. 3 depict flow charts of embodiments of a process for denaturing the proteins within the cheese mass.

In an embodiment, the cheese mass, once heated to the desired temperature, is held at the desired temperature for a required length of time. If the starting form is the desired final form, the cheese is held at temperature in the fixed form and then cooled. If the desired form is different from the starting form, the molten dough-like state allows the cheese to be transformed into a new shape. In an embodiment, the cheese may be made into rolls, sheets, or blocks that fit the dimensions of the desired application by a process of pressing, molding, rolling, extruding, or similar technology. FIG. 2. In an embodiment, the holding time at the target temperature can occur before or after the shape transformation process. FIGS. 3a, 3b, and 3c. In an embodiment, a known heating technology can be used, such as direct contact with a hot surface, steaming, radiofrequency heating, microwave heating, or the combination of the above. The product can be directly exposed to the source of the heat or through a layer of temporary or final packaging material protecting the product from excessive moisture losses or absorption. In an embodiment, following heating, holding, and forming, the cheese is then cooled. FIGS. 3a, 3b, 3c, and 3d. In an embodiment, the cheese is cooled by exposure to a cooling agent comprising air, liquid nitrogen, carbon dioxide, whey, deproteinized whey, brine, water, or a mixture thereof. In an embodiment, the cheese can be packaged or further cut to a size suitable for the final application following cooling. FIG. 3a.

In an embodiment, the process uses heat treatment applied to a natural cheese having a different degree of hydrolysis of caseins to obtain the product of desired functionality. This process does not require any additives such as emulsifying salts or mechanical process such as grinding or stretching or heating in whey to change the functional properties. The ability to heat evenly to high temperatures and the ability to apply this technology to a wide range of cheese types and ages allows this process to produce products with unique and wide ranging functionally.

In an embodiment, the heating treatment causes complete or partial protein denaturation but does not affect the nutritional properties of the proteins because the amino acid composition of the proteins is not changed. In an embodiment, the technology for heating the cheese to desired temperature is selected from the group consisting of conventional, ohmic, microwave, radio frequency, and a combination thereof, allowing for the cheese mass to be heated evenly independently of the size or dimensions of the mass. In an embodiment, the technology for holding the cheese at desired temperature is selected from the group comprising steam, infrared, convection, induction, microwave, ohmic, microwave, radio frequency, and a combination thereof. In an embodiment, the technology for holding the cheese at desired temperature is selected from the group consisting of steam, infrared, convection, induction, microwave, ohmic, microwave, radio frequency, and a combination thereof.

Denaturation can allow the proteins to bind more water. Charged portions of proteins are able bind to water molecules. A protein can bind more water if it is unfolded and can form bonds with other molecules instead of being inside the folded structure of the protein. These bonds reinforce the cheese matrix. Proteins present in cheese include, but are not limited to, casein and whey proteins.

The heating also serves to inactivate proteolytic enzymes, lipolytic enzymes, and microbial organisms. Proteolytic enzyme inactivation prevents 1) protein breakdown into smaller polypeptides or amino acids and 2) the loss of the ability of the cheese to maintain its shape upon heating operations such as frying or grilling, and 3) excessive oiling off and mushiness. Enzyme inactivation and microbial organism inactivation slow down processes associated with aging of the cheese including development of bitterness and associated off-flavors.

The method includes, but is not limited to, inactivation of proteolytic enzymes, lipolytic enzymes, and microbial organisms in dairy cheese and cheese-type products resulting in dairy cheese and cheese-type products that can be fried or grilled while maintaining their consistency and shape, processed into pasta-filata cheeses, or used in pizza type applications. In an embodiment, the method can use any natural cheese as the base. The method can produce products in the style of Halloumi cheese which are also frequently referred to as “grilling cheese” or “frying cheese”. Halloumi-style cheese has a high melting point, allowing it to be fried or grilled while maintaining its consistency and shape. In an embodiment, the chemistry of the cheese can be modified. In an embodiment, the proteins within the cheese can be denatured.

A key step in Halloumi-type cheese manufacturing is a thermal treatment step consisting of submersing the curd or cheese product at high temperatures (about 90-92° C.) in deproteinized whey or whey for an extended time (30-60 minutes) (Robinson, R. K., 1991). Deproteinized whey is the product of removing protein from whey. The main factors determining the length of time for which the cheese is exposed to hot fluid are 1) the heat transfer by conduction and 2) the time/temperature required for obtaining the at least one of the desired level of changes to the cheese chemistry, protein denaturation, and inactivation of proteolytic enzymes, lipolytic enzymes, and microbial organisms. Varying effects upon the changes to the cheese chemistry, protein denaturation, and inactivation of proteolytic enzymes, lipolytic enzymes, and microbial organisms can occur with differences in the time and temperature at which the cheese mass is heated. Variation in the extent that the cheese maintains its shape and consistency can occur with differences in the time and temperature at which the cheese mass is heated.

In an embodiment, one of the methods herein comprises applying an electromagnetic field to a cheese mass with the purpose of obtaining a desired level of at least one of the functional changes to the cheese chemistry, protein denaturation, and inactivation of proteolytic enzymes, lipolytic enzymes, and microbial organisms by generating heat volumetrically by dissipation of electrical current, passing through the product, into heat. In an embodiment, the electromagnetic field is applied in the form of pulses. Heat is generated internally within the cheese mass. The method allows rapid heating to temperatures required for obtaining desired levels of at least one of the following changes to the cheese chemistry, protein denaturation, and inactivation of proteolytic enzymes, lipolytic enzymes, and microbial organisms. In an embodiment, the electric field is applied to the product by the means of electrodes. In an embodiment, there are two or more electrodes. In an embodiment, the electrodes are directly in contact with the product or separated by a layer of electrically conductive fluid (including, but not limited to, whey, deproteinated whey, brine, water, or a mixture thereof). In an embodiment, the cheese product is treated in a form including but not limited to curd, particles, ground cheese, shredded cheese, blocks, or continuously extruded cheese. In an embodiment, the cheese product can be immobile or moving relative to the surfaces of the electrodes. Each of the electrodes can be potential, neutral, or ground. In an embodiment, the generator is outputting single or three separate electric fields with phases differing by a third of a period. In an embodiment, the frequency of the electric field ranges from 0 Hz to 1 MHz. In an embodiment, the desired frequency ranges from 10 kHz to 400 kHz.

In an embodiment, the electrodes are made from food grade electrically conductive material, including but not limited to, stainless steel, titanium and platinized titanium. In an embodiment, the electric field generated by the generator provides monopolar or bipolar pulses. In an embodiment, the pulses are of fixed or adjustable duration with or without delays between pulses. The selection of optimal electric field parameters and treatment time is based on the required product heating rate, power efficiency, and desired suppression of electrochemical corrosion of electrodes.

The rate of ohmic heating is proportional to the square of the electric field strength and the electrical conductivity. If the cheese or cheese-type product has more than one phase, the electrical conductivity of all phases should be considered. The heat transfer within the cheese mass is considered to be by conduction with internal energy generation. Ruan et al. (2001). In an embodiment, the electrical conductivity of the cheese ranges from 0.01 to 10 S/m at a temperature of 20° C. In an embodiment, the thermal conductivity of the cheese ranges from 0.19 to 0.6 W/mK at a temperature of 20° C. In an embodiment, the specific heat of the cheese ranges from 2 to 3.8 kJ/kg° C.

In an embodiment, the methods herein employ ohmic, microwave, radio frequency heating, or a combination thereof. In an embodiment, the methods herein employ ohmic heating for changing at least one of cheese chemistry and denaturation of dairy proteins in order to obtaining a cheese product which can be fried or grilled while maintaining its consistency and shape. The efficiency of the manufacturing process and the quality of the final product will be superior compared to the conventional practice. Lower fat and soluble constituent losses can be obtained by employing the proposed method.

An embodiment of the disclosure is a method of producing a cheese that maintains its consistency and shape after application of heat treatment. The desired functionality is achieved by at least one of modifying the cheese chemistry, completely or partially denaturing proteins within a cheese mass; and inactivating proteolytic and lipolytic enzymes and microbial organisms within the cheese by a method comprising heating the cheese to a desired temperature using an applied electric field provided by electrodes; and holding the cheese at a desired temperature for a desired time; and wherein the cheese obtained maintains its consistency and shape upon cooking steps, such as frying or grilling.

In an embodiment, the cheese is produced by the method comprising subjecting at least one selected from the group consisting of milk, nonfat milk, and cream to the action of an acid or lactic acid-producing bacterial culture; adding at least one clotting enzyme to the ingredients to set them into a semisolid mass or using none; cutting the semi-solid mass; stirring the semisolid mass; heating the semisolid mass with continued stirring to cause separation of whey and curd; draining off the whey; matting the curd into a cohesive mass to create a milled curd; allowing the cohesive mass to set; cutting the cohesive mass into pieces by milling; salting the curd; stirring the curd; and draining the curd and then pressing or extruding it into the desired form. In an embodiment, heating can be applied before pressing or extruding. In an embodiment, heating can be applied after pressing or extruding. In an embodiment, the method further comprises adding coloring to the milk to change the cheese color. In an embodiment, the method further comprises adding calcium chloride to the dairy ingredients as a coagulation aid. In an embodiment, the clotting enzymes are of animal, plant, or microbial origin. In an embodiment, the cheese is produced without the addition of the clotting enzymes. In an embodiment, the cheese is produced without the addition of lactic acid bacteria or acid.

In an embodiment, before heating, inclusions can be optionally added to the cheese. In an embodiment, the one or more inclusions can include but are not limited to meats, fruits, vegetables, legumes, tree nuts, seeds, herbs, spices, alcoholic substances, or flavorings. In an embodiment, the one or more inclusions can include but are not limited to bacon, pepperoni, salami, ham, jalapeno peppers, habanero peppers, serrano peppers, green peppers, red peppers, almonds, peanuts, truffles, mushrooms, tomatoes (sun-dried and otherwise), basil, oregano, olives, cranberries, berries, cherries, coffee beans, garbanzo beans, plums, peaches, chia seeds, coriander, grains, fungi, wasabi, or horseradish.

In an embodiment, the age of the cheese is ranging from fresh curd to 52 weeks at normal storage or aging conditions (excluding the time of frozen storage).

In an embodiment, cheese could be frozen for any time length and then heated to produce a product similar to that obtained where fresh cheese is used.

In an embodiment, the desired temperature ranges from 50° C. to 170° C. In an embodiment, the desired temperature ranges from 90° C. to 110° C.

In an embodiment, the desired heating time ranges from 30 seconds to 12 hours. In an embodiment, the desired heating time ranges from 5 minutes to 60 minutes.

In an embodiment, the electric field is applied directly to the cheese mass via electrodes. In an embodiment, no fluid is used in heating the cheese. In an embodiment, the method further comprises an electrically conductive fluid between electrodes and the cheese mass. In an embodiment, the electrically conductive fluid comprises whey, deproteinated whey, brine, water, or a mixture thereof. In an embodiment, the cheese mass is treated in the form of one selected from the group consisting of curd, particles, ground cheese, shredded cheese, blocks, and extruded. In an embodiment, the cheese mass is immobile relative to the electrodes. In an embodiment, the cheese mass moves along the surface of the electrodes. In an embodiment, the applied electric field consists of monopolar pulses. In an embodiment, the applied electric field consists of bipolar pulses. In an embodiment, the applied electric field has pulses with a fixed, variable, or adjustable amplitude and duration. In an embodiment, the applied electric field has delays between pulses. In an embodiment, the applied electric field does not have delays between pulses. In an embodiment, the frequency of pulses ranges from 0 Hz to 1 MHz. In an embodiment, the desired frequency ranges from 10 kHz to 400 kHz. In an embodiment, the electrodes are comprised of a food grade electrically conductive material. In an embodiment, the material is comprised of stainless steel or platinized titanium. In an embodiment, the electrodes number two or more electrodes.

In an embodiment, in order to retain original flavor and nutritional value of cheese, the surface of the cheese is denatured such that it is fried or grilled while maintaining its consistency and shape. In an embodiment, the present disclosure provides a method of heating a cheese to make the surface layer reach a higher temperature than the interior of the cheese, such that the surface layer is denatured, and at the same time, the interior of the cheese keeps its nature.

In an embodiment, the cheese, once processed, is cooled to storage temperature by exposure directly or indirectly to a cooling agent comprising air, liquid nitrogen, carbon dioxide, whey, deproteinized whey, brine, water, or a mixture thereof.

In an embodiment, the cheese, once processed, is packaged and cooled to storage temperature by exposure directly or indirectly to a cooling agent comprising air, liquid nitrogen, carbon dioxide, whey, deproteinized whey, brine, water, or a mixture thereof. In an embodiment, maintaining consistency is defined as maintaining the uniform distribution of constituents (including but not limited to fat, proteins, and water) among the cheese mass.

In an embodiment, maintaining shape is defined as maintaining the amount of space and structure that the cheese product occupies at normal storage conditions.

Those familiar with the art will understand that a combination of factors such as pH, ionic composition, and ingredient interaction can affect the time and temperature selection.

All of the compositions and methods disclosed and claimed herein can be made and executed without undue experimentation in light of the present disclosure. While the compositions and methods of this disclosure have been described in terms of preferred embodiments, it will be apparent to those of skill in the art that variations may be applied to the compositions and methods and in the steps or in the sequence of steps of the methods described herein without departing from the concept, spirit and scope of the disclosure. More specifically, it will be apparent that certain agents which are both chemically related may be substituted for the agents described herein while the same or similar results would be achieved. All such similar substitutes and modifications apparent to those skilled in the art are deemed to be within the spirit, scope and concept of the disclosure as defined by the appended claims.

### REFERENCES

Arding, Separation Anxiety, available at https://culturecheesemag.com/cheese-iq/separation-anxiety (Sep. 4, 2010).
Boutureira, Omar and Bernardes, Goncalo, (2015) Advances in Chemical Protein Modification, Chemical Reviews, 115, 2174-2195.
Gaucheron, Frederic. The minerals of milk. Reproduction Nutrition Development, EDP Sciences, 2005, 45 (4), pp. 473-483.
Robinson, R. K. (1991) Halloumi cheese—the product and its manufacture. In R. K. Robinson et al. (Ed.), Feta and related cheeses. Cambridge: Woodhead Publishing Ltd.
R. Ruan, X. Ye, P. Chen and C. J. Doona, and I. Taub, (2001), Chapter 13, Ohmic heating at page 242 (available at http://discipilinas.stoa.us.br/pluginfile.php/128439/mod_resource/content/1/cr1216_13.pdf).
Sigma-Aldrich, General Properties of Casein, (available at http://www.sigmaaldrich.com/life-science/metabolomics/enzyme-explorer/enzyme-reagents/casein.html).

What is claimed is:

1. A method of producing a cheese for grilling or frying applications comprising:
controlling a consistency of flow and shape of the cheese upon heating;
controlling a degree of oiling off of the cheese; and
controlling a desired degree of melting of the cheese while controlling the degree of oiling off of the cheese.

2. The method of claim 1, wherein the heating of the cheese is by the method selected from the group comprising steam, infrared, convection, induction, ohmic, microwave, radio frequency, and a combination thereof.

3. The method of claim 1 further comprising modifying the chemistry of the cheese.

4. The method of claim 1 further comprising denaturing the proteins within a cheese mass.

5. The method of claim 1 further comprising inactivating proteolytic enzymes, lipolytic enzymes, and microbial organisms within the cheese.

6. The method of claim 1, wherein the age of the cheese ranges from fresh curd to 52 weeks.

7. The method of claim 2, wherein a desired temperature ranges from 50° C. to 170° C.

8. The method of claim 1, wherein the desired holding time ranges from 0 to 12 hours.

9. The method of claim 2, wherein the heating of the cheese uses an electrically conductive fluid.

10. The method of claim 1, wherein the cheese is treated in a form selected from the group comprising curd, particles, ground cheese, shredded cheese, blocks, and extruded cheese.

11. The method of claim 2, wherein an applied electric field is comprised of monopolar pulses or bipolar pulses.

12. The method of claim 2, wherein an applied electric field has delays between pulses.

13. The method of claim 2, wherein the frequency of pulses ranges from 0 Hz to 1 MHz.

14. The method of claim 2, wherein the heating of the cheese utilizes one or more electrodes comprised at least one selected from the group comprising stainless steel, titanium, platinized titanium, or a mixture thereof.

15. The method of claim 1, further comprising holding the cheese at a temperature in the fixed form after heating; followed by cooling, to obtain a desired final form of the cheese that is the same as a starting form of the cheese.

16. The method of claim 15, wherein the cheese is packaged and cooled to storage temperature by direct or indirect exposure to a cooling agent comprising air, liquid nitrogen, carbon dioxide, whey, deproteinized whey, brine, water, or a mixture thereof.

17. The method of claim 1, wherein the cheese is cooled to a desired temperature after processing.

18. The method of claim 1, further comprising forming the cheese into a desired shape before cooling the cheese to a desired temperature.

19. The method of claim 1, further comprising forming the cheese into a desired shape before holding the cheese at a desired temperature for a desired time.

20. A method of inactivating proteolytic enzymes, lipolytic enzymes, and microbial organisms within the cheese by a method comprising
heating the cheese to a desired temperature;
holding the cheese at a desired temperature for a desired time; and
cooling the cheese to a desired temperature;
wherein the cheese obtained maintains desirable functional properties for an extended period of time after the treatment application.
